(19) United States
(12) Patent Application Publication
(10) Pub. No.: US 2021/0204666 A1
(43) Pub. Date: Jul. 8, 2021

(54) FLEXIBLE PROTECTIVE COVER WITH LIGHT EMITTING NET COVER

(71) Applicant: COOLGENETEK LTD., NEW TAIPEI CITY (TW)

(72) Inventor: Yung-Lin HSU, NEW TAIPEI CITY (TW)

(21) Appl. No.: 17/141,705

(22) Filed: Jan. 5, 2021

(30) Foreign Application Priority Data
Jan. 8, 2020 (TW) 109100582

(51) Int. Cl. A45C 15/06; F21V 8/00; F21V 23/00; F21V 23/04; G06F 1/18; D03D 15/547; A45C 13/00; A45C 13/10

(52) U.S. Cl. CPC A45C 15/06; G02B 6/001; F21V 23/003; F21V 23/04; F21Y 2115/10; D03D 15/547; A45C 13/002; A45C 13/103; G06F 1/182

(57) ABSTRACT

A flexible protective cover with a light emitting net cover is provided. The flexible protective cover (10) includes a flexible cover body (1) and a light emitting net cover (2). The flexible cover body (1) includes an opening (11) and is composed of a leather, a fabric, a silicone, or a rubber material. The light emitting net cover (2) includes a light guiding net (21) and a light emitting module (22). The light guiding net (21) is fixed on the flexible cover body (1) and includes a weaving net portion (212). The weaving net portion (212) is woven by multiple optical fibers (211) and covers the opening (11). The light emitting module (22) includes a LED (221) arranged correspondingly to the plurality of optical fibers (211). The purpose of the flexible protective cover (10) having soft casing and special visual effect such as meshed light effect may be achieved.

### BACKGROUND OF THE INVENTION

### Technical Field

The present invention relates to a protective cover for covering a host, and particularly relates to a flexible protective cover with a light emitting net cover.

### Related Art

The protective cover of computer host is generally made by hard casing with the material like plastic or metal. For increasing visualization, the hard casing is usually disposed with an opening and multiple light emitting units are installed on the opening. Thus, the protective cover of computer host has light emitting function.

However, the styles of the protective cover made by plastic or metal are limited. Further, the light emitting units appear to be multiple dots and emit light respectively as monotonic light emitting form. As a result, the protective cover of computer host is lack of personalized, special, and novel visual effects.

Accordingly, the applicant of the present invention has devoted himself for improving the mentioned disadvantages.

### SUMMARY OF THE INVENTION

The present invention provides a flexible protective cover with a light emitting net cover. The flexible protective cover uses a flexible cover body to cover an exterior of a host and a light emitting diode (LED) for transmitting light to a plurality of optical fibers. As a result, the weaving net portion may present visual perception with meshed light effect and further achieve the purpose of the flexible protective cover having soft casing and personalized, special, novel visual effects such as meshed light effect.

In some embodiments of the present invention, a flexible protective cover with a light emitting net cover is provided. The flexible protective cover is incorporated with a host. The flexible protective cover includes: a flexible cover body covering an exterior of the host and including at least one opening and composed of a leather, a fabric, a silicone or a rubber material; and at least one light emitting net cover including: a light guiding net fixed on the flexible cover body and including a weaving net portion, wherein the flexible cover body is woven by a plurality of optical fibers and covers the opening; and a light emitting module including at least one LED arranged correspondingly to the plurality of optical fibers.

In summary, the weaving net portion covers the opening of the flexible cover body and the LED transmits light to whole of the weaving net portion through the plurality of optical fibers. As a result, the opening of the flexible cover body may present visual perception with meshed light effect. A shape of the opening may be at least one of a pattern, a word, a symbol, or a combination thereof. Further, the aesthetic appearance and decoration of the flexible cover body may be improved.

Moreover, the weaving net portion includes a plurality of warp-wise optical fibers and a plurality of weft-wise light transmitting yarns woven as warp and weft. The weaving net portion may have woven fabric texture. The weft-wise light transmitting yarns have light permeable function and the light of the LED may transmit stably to whole of the weaving net portion. The light emitting efficiency of the weaving net portion may be increased.

Further, the flexible cover body includes a through opening and a wing sheet covering the through opening. The wing sheet exposes or closes the through opening by a connecting assembly. The host may optionally be withdrawn from the flexible cover body through the through opening or confined and accommodated inside of the flexible cover body.

### BRIEF DESCRIPTION OF THE DRAWINGS

FIG. 1 is a perspective view illustrating the first embodiment of the flexible protective cover in the present invention;

FIG. 2 is a schematic view illustrating the operating status of the first embodiment of the weaving net cover in the present invention;

FIG. 3 is a partial enlarged view of the first embodiment of the weaving net portion in the present invention;

FIG. 4 is a front view illustrating the second embodiment of the flexible protective cover in the present invention;

FIG. 5 is a front view illustrating the third embodiment of the flexible protective cover in the present invention;

FIG. 6 is a front view illustrating the fourth embodiment of the flexible protective cover in the present invention;

FIG. 7 is a front view illustrating the fifth embodiment of the flexible protective cover in the present invention;

FIG. 8 is an expansion view illustrating the sixth embodiment of the flexible protective cover in the present invention;

FIG. 9 is an expansion view illustrating the seventh embodiment of the flexible protective cover in the present invention;

FIG. 10 is a perspective view illustrating the eighth embodiment of the flexible protective cover in the present invention;

FIG. 11 is a schematic view illustrating the operating status of the second embodiment of the weaving net cover in the present invention;

FIG. 12 is a partial enlarged view of the second embodiment of the weaving net portion in the present invention;

FIG. 13 is a schematic view illustrating the operating status of the third embodiment of the weaving net cover in the present invention;

FIG. 14 is a partial enlarged view of the third embodiment of the weaving net portion in the present invention; and

FIG. 15 is a schematic view illustrating the operating status of the fourth embodiment of the weaving net cover in the present invention.

### DETAILED DESCRIPTION OF THE INVENTION

The embodiments of the present invention will be described with reference to the drawings. These are, of course, merely examples and are not intended to be limiting.

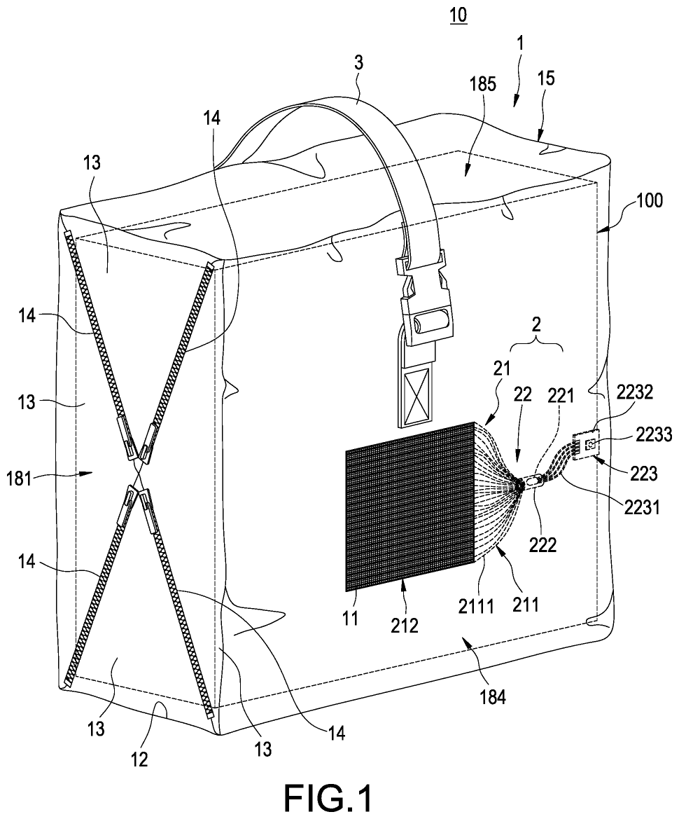

Referring to FIG. 1 to FIG. 3, the first embodiment of a flexible protective cover with a light emitting net cover is provided in the present invention. The flexible protective cover is incorporated (or used, or applied) with, for examples, a host 100 of electronic products such as computer. The flexible protective cover 10 includes a flexible cover body 1 and one or multiple light emitting net covers 2.

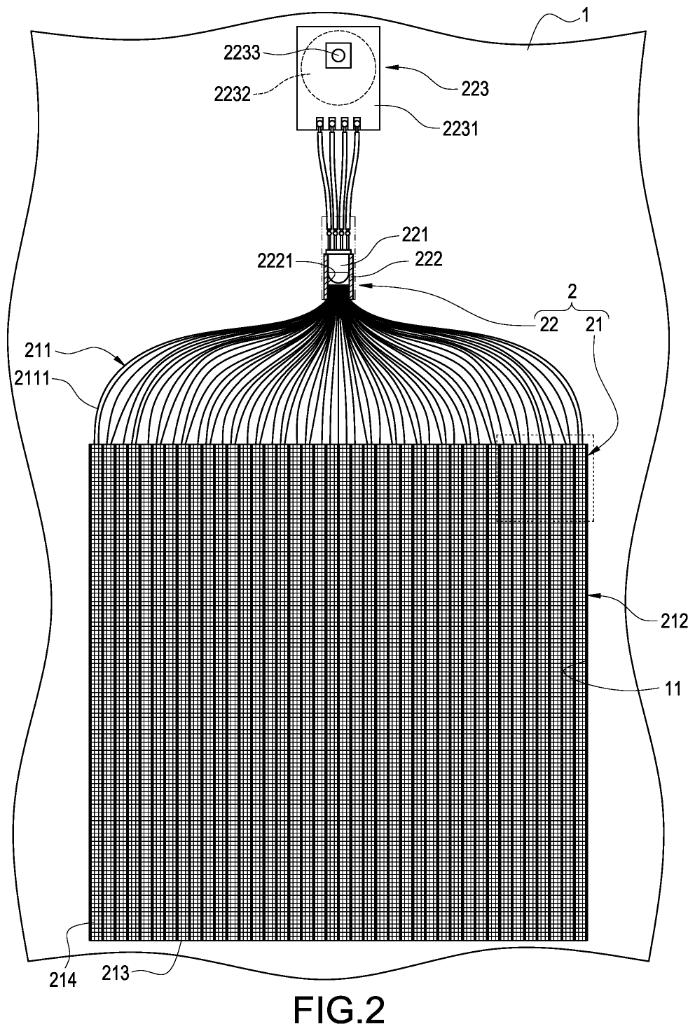

Referring to FIG. 1 and FIG. 2, the flexible cover body 1 may be composed of flexible materials; the flexible material is for example but not limited to, a leather, a fabric, a silicone, or a rubber, etc. The flexible cover body 1 covers an exterior of the host 100. The flexible cover body 1 is disposed with one or multiple openings 11. The shape of the opening 11 may be at least one of a pattern, a word, a symbol, or a combination thereof. In some embodiments, an amount of the opening 11 is, but not limited to, one.

Further, the flexible cover body 1 may be further disposed with a through opening 12 and may include one or multiple wing sheets 13. In some embodiments, an amount of the wing sheet 13 is multiple. One portion of each of the multiple wing sheets 13 is extended and formed from an inner periphery of the through opening 12 and covers the through opening 12. The other portions of the multiple wing sheets 13 are connected with each other by a connecting assembly (such as a first connecting assembly) 14. The connecting assembly 14 may be a zipper, a hook-and-loop fastener, a set of male/female buckles or an adhesive tape. When the connecting assembly 14 are disconnected to expose the through opening 12, the host 100 may be withdrew from the flexible cover body 1 through the through opening 12. When the connecting assembly 14 are connected to close the through opening 12, the host 100 is confined and accommodated inside of the flexible cover body 1.

Specifically, in some embodiments, an amount of the wing sheet 13 is four. One portion of each of four wing sheets 13 is extended and formed from the inner periphery of the through opening 12 and the other portions of four wing sheets 13 are connected with each other by the connecting assembly (zipper) 14. A shape of the through opening 12 is rectangular. A shape of the wing sheet 13 is triangular. A shape of the connecting assembly 14 is X shape. Thus, four wing sheets 13 may expose or close the through opening 12 jointly, but here is not intended to be limiting.

Further, in some embodiments, the flexible cover body 1 may be constituted by a box-shape casing 15. The box-shape casing 15 is disposed to have a front surface 181, a back surface (not shown in the figures), a left surface (not shown in the figures), a right surface 184 and a top surface 185. The opening 11 is disposed on the right surface 184. The through opening 12 is disposed on the front surface 181. Here is not intended to be limiting, the opening 11 and through opening 12 may be disposed at any location of the flexible cover body 1.

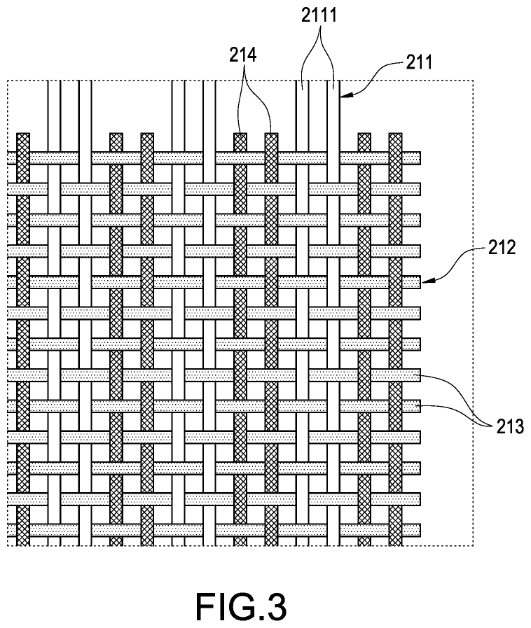

Referring to FIG. 2 and FIG. 3, the light emitting net cover 2 includes a light guiding net 21 and a light emitting module 22. The light guiding net 21 is fixed on the flexible cover body 1. The light guiding net 21 includes a weaving net portion 212. The weaving net portion 212 is woven by a plurality of optical fibers 211. The weaving net portion 212 covers the opening 11. The light emitting module 22 includes one or multiple LEDs 221 arranged correspondingly to the plurality of optical fibers 211.

Specifically, FIG. 3 is the first embodiment of the weaving net portion 212 in the present invention. In some embodiments, the multiple optical fibers 211 are multiple warp-wise optical fibers 2111 arranged parallelly in warp-wise. The light guiding net 21 further includes multiple weft-wise light transmitting yarns 213 arranged parallelly in weft-wise and a plurality of warp-wise light reflecting yarns 214 arranged parallelly in warp-wise. The multiple warp-wise light reflecting yarns 214 and the multiple warp-wise optical fibers 2111 are interweaved parallelly. The multiple warp-wise optical fibers 2111, the multiple warp-wise light reflecting yarns 214 and the multiple weft-wise light transmitting yarns 213 are woven as warp and weft to form the weaving net portion 212. The weft-wise light transmitting yarns 213 may be, but not limited to, voile. The warp-wise light reflecting yarns 214 are composed of high tenacity yarns with glass light reflecting particles (glitters) adhered on the outer surface.

In some embodiments, an amount of the LED 221 is one. In some embodiments, the light emitting module 22 further includes a fixing bushing 222 and a power controlling element 223. One end of the fixing bushing 222 is disposed at (or sheathes) terminals of the plurality of warp-wise optical fibers 2111, and terminals of the plurality of warp-wise optical fibers 2111 are tightened (packed) by the end of the fixing bushing 222. Another end of the fixing bushing 222 connects (or sockets) with the LED 221. The LED 221 is electrically connected to the power controlling element 223.

The fixing bushing 222 may be composed of metal material, or an inner periphery of the fixing bushing 222 may be covered by a light reflecting layer. Thus, the inner periphery of the fixing bushing 222 may have a light reflecting inner wall 2221. The light of the LED 221 may be reflected by the light reflecting inner wall 2221 to be stably transmitted to the multiple optical fibers 211.

Moreover, in some embodiments, the power controlling element 223 includes, but not limited to, a circuit board 2231 electrically connected with the LED 221, a battery 2232 installed (or disposed) on the circuit board 2231 and a switch 2233. The circuit board 2231 senses the pressing of the switch 2233 for determining either to provide power to the LED 221 or disconnect power from the LED 221. The LED 221 is thus controlled to be lit up or extinguished.

Referring to FIG. 3, the flexible protective cover 10 further includes a carrying belt 3. The carrying belt 3 is attachably/detachably connected to and fixed on a top portion of the flexible cover body 1. In other words, the carrying belt 3 may be attached to or detached from the top portion of the flexible cover body 1. Thereby, when the carrying belt 3 is connected to and fixed on a top portion of the flexible cover body 1, the user may effortlessly carry the flexible cover body 1 and the host 100 therein.

Referring to FIG. 1 to FIG. 3, the operation status of the flexible protective cover 10 is illustrated. The flexible cover body 1 may be composed of flexible materials; the flexible material is for example but not limited to, a leather, a fabric, a silicone, or a rubber, etc. The flexible cover body 1 covers an exterior of the host 100. The weaving net portion 212 covers the opening 11 of the flexible cover body 1. The LED 221 transmits the light through the multiple optical fibers 211 to whole of the weaving net portion 212. As a result, the opening 11 of the flexible cover body 1 may present visual perception with meshed light effect. A shape of the opening 11 may be at least one of a pattern, a word, a symbol, or a combination thereof. Further, the aesthetic appearance and decoration of the flexible cover body 1 may be improved and the purpose of the flexible protective cover 10 having soft casing and personalized, special, novel visual effects such as meshed light effect may be achieved.

In some embodiments, the weaving net portion 212 includes a plurality of warp-wise optical fibers 2111 and a plurality of weft-wise light transmitting yarns 213 woven as warp and weft. The weaving net portion 212 may have woven fabric texture. The weft-wise light transmitting yarns 213 have light permeable function and the light of the LED 221 may transmit stably to whole of the weaving net portion 212. The light emitting efficiency of the weaving net portion 212 may be increased.

Moreover, the plurality of warp-wise light reflecting yarns 214 and the plurality of warp-wise optical fibers 2111 are interweaved parallelly for the warp-wise light reflecting yarns 214 reflecting the light refracted by the warp-wise optical fibers 2111. Further, the warp-wise light reflecting yarns 214 and the warp-wise optical fibers 2111 are arranged parallelly to prevent from blocking the light transmission of the warp-wise optical fibers 2111. The light emitting efficiency of the weaving net portion 212 may be increased.

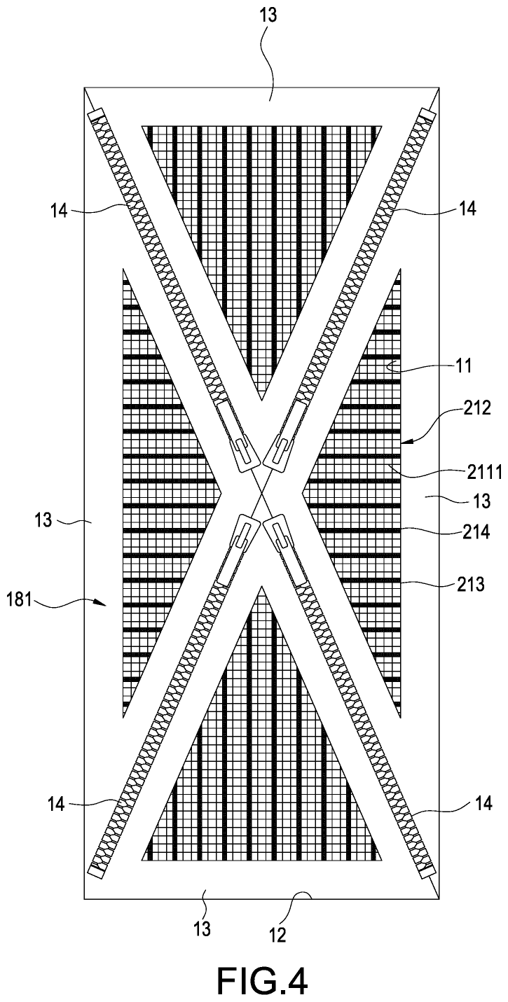

Referring to FIG. 4, the second embodiment of the flexible protective cover 10 in the present invention is illustrated. The embodiment in FIG. 4 is similar to the embodiment in FIG. 1 to FIG. 3. The difference between the embodiment in FIG. 4 and the embodiment in FIG. 1 to FIG. 3 is that the wing sheet 13 is opened to form and dispose the opening 11. Thus, the wing sheet 13 may have the visual effects such as meshed light effect.

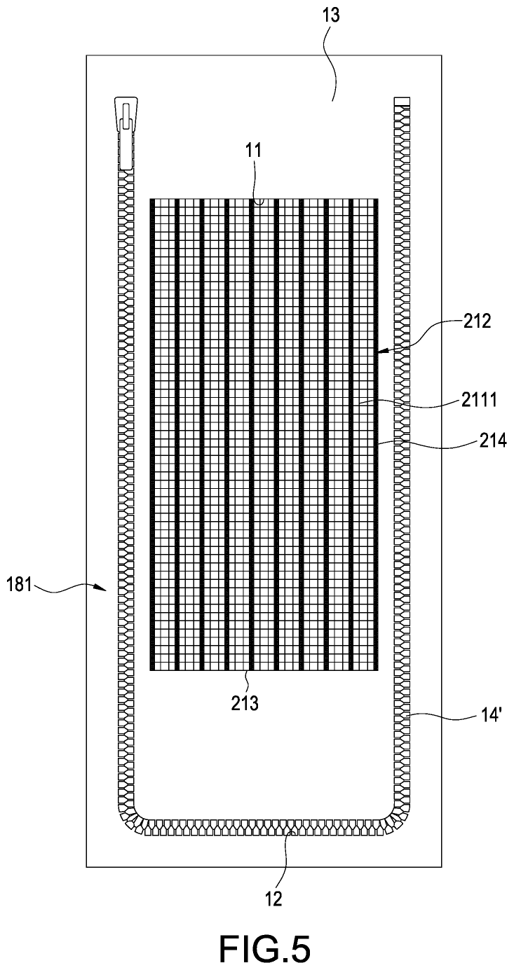

Referring to FIG. 5, the third embodiment of the flexible protective cover 10 in the present invention is illustrated. The embodiment in FIG. 5 is similar to the embodiment in FIG. 4. The difference between the embodiment in FIG. 5 and the embodiment in FIG. 4 is that an amount of the wing sheet 13 is one. One portion of the wing sheet 13 is formed by extending from an inner periphery of the through opening 12. The other portion of the wing sheet 13 and the inner periphery of the through opening 12 are connected with each other by a connecting assembly (such as a second connecting assembly) 14′ (zipper). The shape of the through opening 12 is rectangular. The shape of the wing sheet 13 is rectangular. The shape of the connecting assembly 14′ is U-shape. Thereby, the wing sheet 13 may expose or close the through opening 12. The connecting assembly 14′ may be, but not limited to, a zipper, a hook-and-loop fastener, a set of male/female buckles or an adhesive tape.

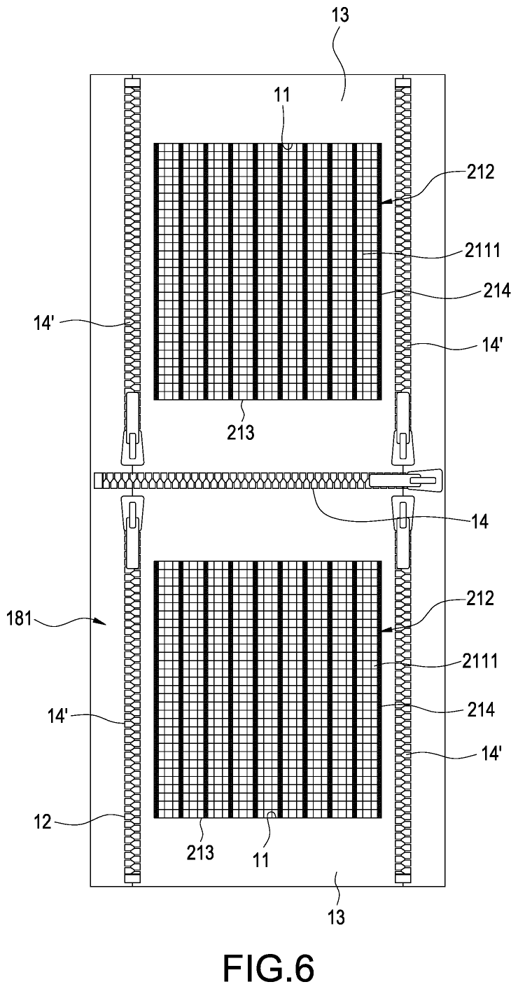

Referring to FIG. 6, the fourth embodiment of the flexible protective cover 10 in the present invention is illustrated. The embodiment in FIG. 6 is similar to the embodiment in FIG. 4. The difference between the embodiment in FIG. 6 and the embodiment in FIG. 4 is that an amount of the wing sheet 13 is multiple. One portion of each of the wing sheets 13 is formed by extending from an inner periphery of the through opening 12. The other portion of each of the wing sheets 13 and the inner periphery of the through opening 12 are connected with each other by a connecting assembly 14′ (zipper). The residual portions of the multiple wing sheets 13 are connected with each other by connecting assembly 14. The shape of the through opening 12 is rectangular. The shape of the wing sheet 13 is rectangular. The shapes of the connecting assemblies 14, 14′ are H-shape. Thereby, the wing sheets 13 may expose or close the through opening 12.

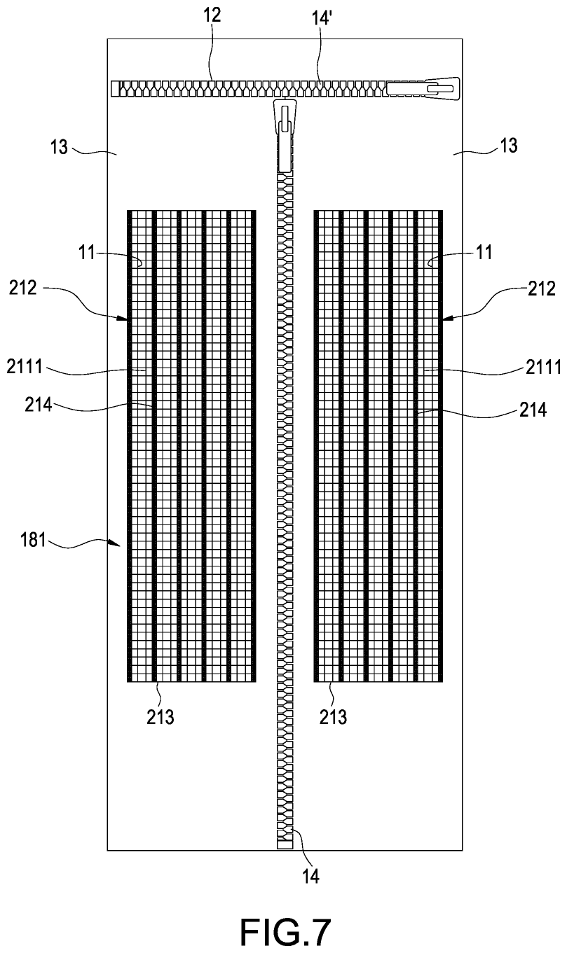

Referring to FIG. 7, the fifth embodiment of the flexible protective cover 10 in the present invention is illustrated. The embodiment in FIG. 7 is similar to the embodiment in FIG. 4. The difference between the embodiment in FIG. 7 and the embodiment in FIG. 4 is that an amount of the wing sheet 13 is multiple. One portion of each of the wing sheets 13 is formed by extending from an inner periphery of the through opening 12. The other portion of each of the wing sheets 13 and the inner periphery of the through opening 12 are connected with each other by a connecting assembly 14′ (zipper). The residual portions of the multiple wing sheets 13 are connected with each other by connecting assembly 14. The shape of the through opening 12 is rectangular. The shape of the wing sheet 13 is rectangular. The shapes of the connecting assemblies 14, 14′ are T-shape. Thereby, the wing sheets 13 may expose or close the through opening 12.

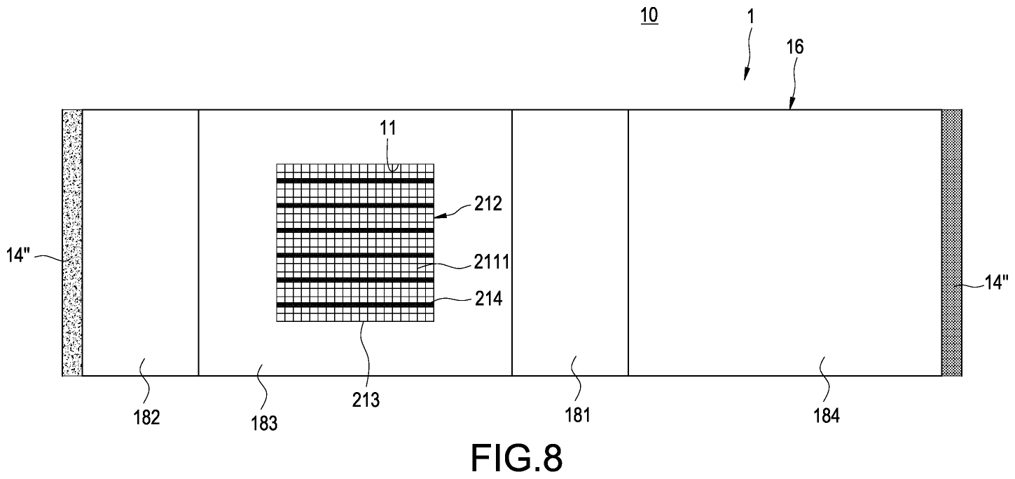

Referring to FIG. 8, the sixth embodiment of the flexible protective cover 10 in the present invention is illustrated. The embodiment in FIG. 8 is similar to the embodiment in FIG. 1 to FIG. 3. The difference between the embodiment in FIG. 8 and the embodiment in FIG. 1 to FIG. 3 is that the flexible cover body 1 is a non-box-shape casing. The flexible cover body 1 is constituted by a strap-type (or band-type) sheet 16. A left end and a right end of the strap-type sheet 16 are connected with each other by a connecting assembly (such as a third connecting assembly) 14″. The strap-type sheet 16 is disposed to have a front surface 181, a back surface 182, a left surface 183 and a right surface 184. The connecting assembly 14″ may be, but not limited to, a zipper, a hook-and-loop fastener, a set of male/female buckles or an adhesive tape. It should be noted that the through opening 12 (as shown in FIG. 1) may be omitted. The opening 11 is disposed on the left surface 183. The opening 11 and through opening 12 (as shown in FIG. 1) may be disposed on any position of the flexible cover body 1 and here is not intended to be limiting.

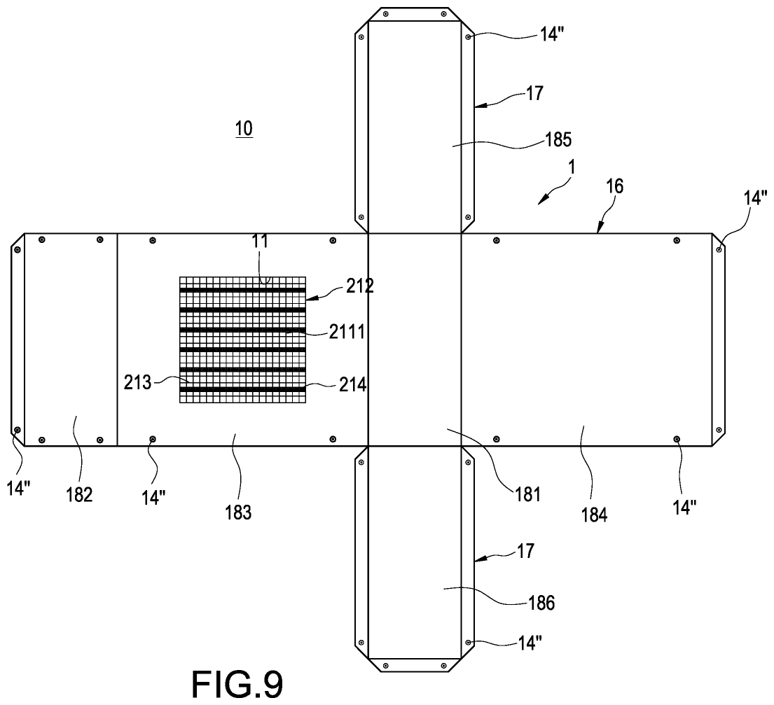

Referring to FIG. 9, the seventh embodiment of the flexible protective cover 10 in the present invention is illustrated. The embodiment in FIG. 9 is similar to the embodiment in FIG. 8. The difference between the embodiment in FIG. 9 and the embodiment in FIG. 8 is that two rectangular sheets 17 are extended respectively from an upper side and a lower side of one strap-type sheet 16. The outer peripheries of the strap-type sheet 16 and the rectangular sheets 17 are connected with each other by a connecting assembly 14″. The strap-type sheet 16 and the rectangular sheets 17 are disposed to have a front surface 181, a back surface 182, a left surface 183, a right surface 184, a top surface 185 and a bottom surface 186. The opening 11 and through opening 12 (as shown in FIG. 1) may be disposed on any position of the flexible cover body 1 and here is not intended to be limiting.

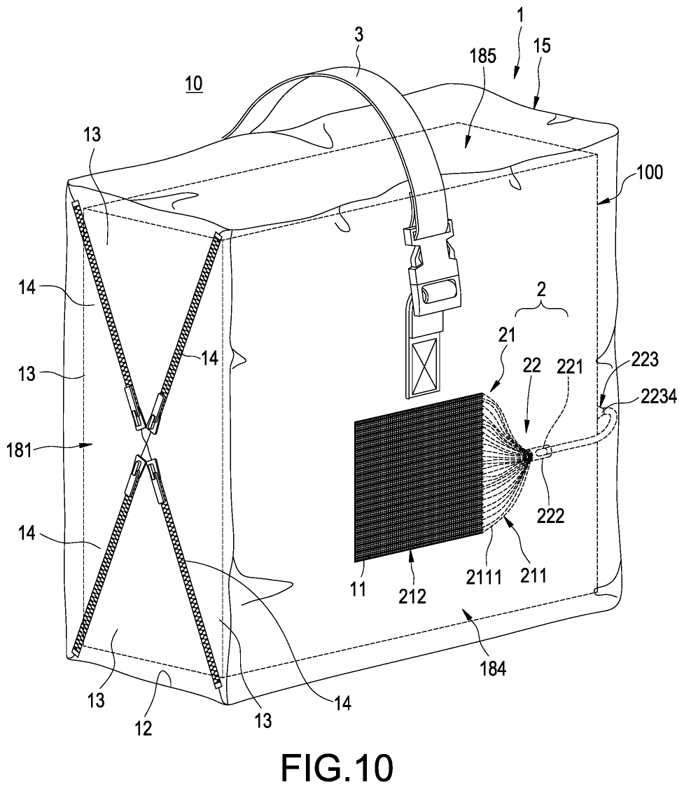

Referring to FIG. 10, the eighth embodiment of the flexible protective cover 10 in the present invention is illustrated. The embodiment in FIG. 10 is similar to the embodiment in FIG. 1 to FIG. 3. The difference between the embodiment in FIG. 10 and the embodiment in FIG. 1 to FIG. 3 is that the power controlling element 223 does not have battery and switch. The power controlling element 223 includes a connector 2234. The connector 2234 is electrically connected with the LED 221 and attachably/detachably connected to the host 100. In other words, the connector 2234 may be attached to or detached from the host 100. The host 100 provides power to the LED 221 or disconnects power from the LED 221 through the connector 2234.

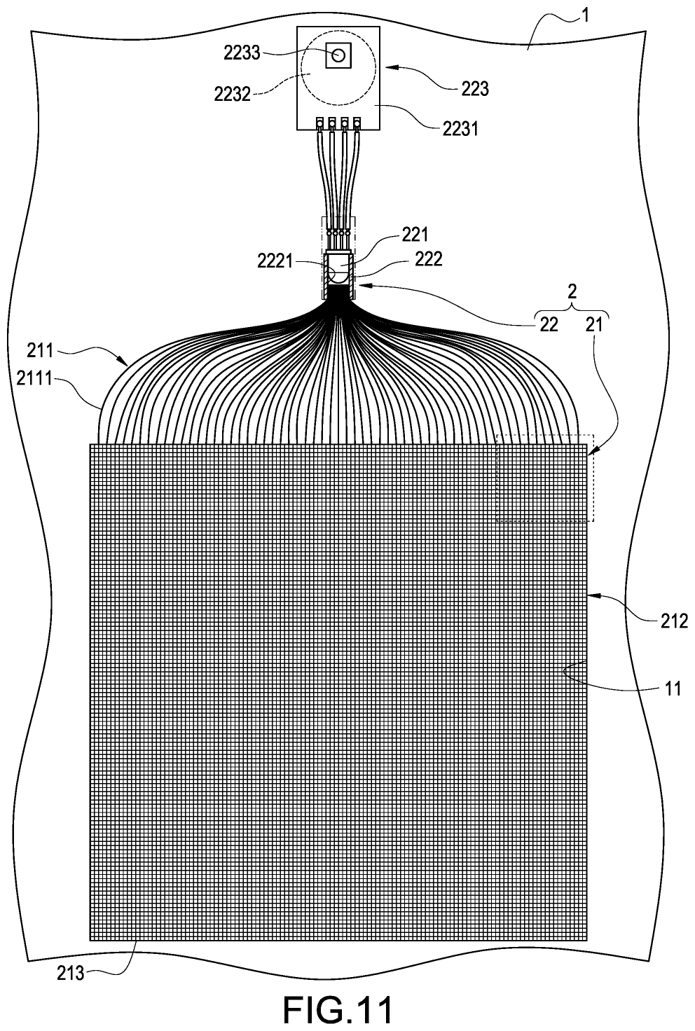

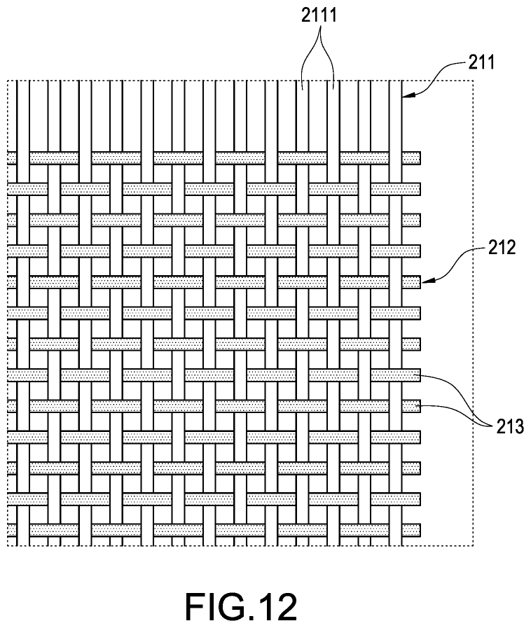

Referring to FIG. 11 and FIG. 12, the second embodiment of the weaving net portion 212 in the present invention is illustrated. The embodiment in FIG. 11 and FIG. 12 is similar to the embodiment in FIG. 1 to FIG. 3. The difference between the embodiment in FIG. 11 to FIG. 12 and the embodiment in FIG. 1 to FIG. 3 is that the warp-wise light reflecting yarns 214 (as shown in FIG. 3) may be omitted.

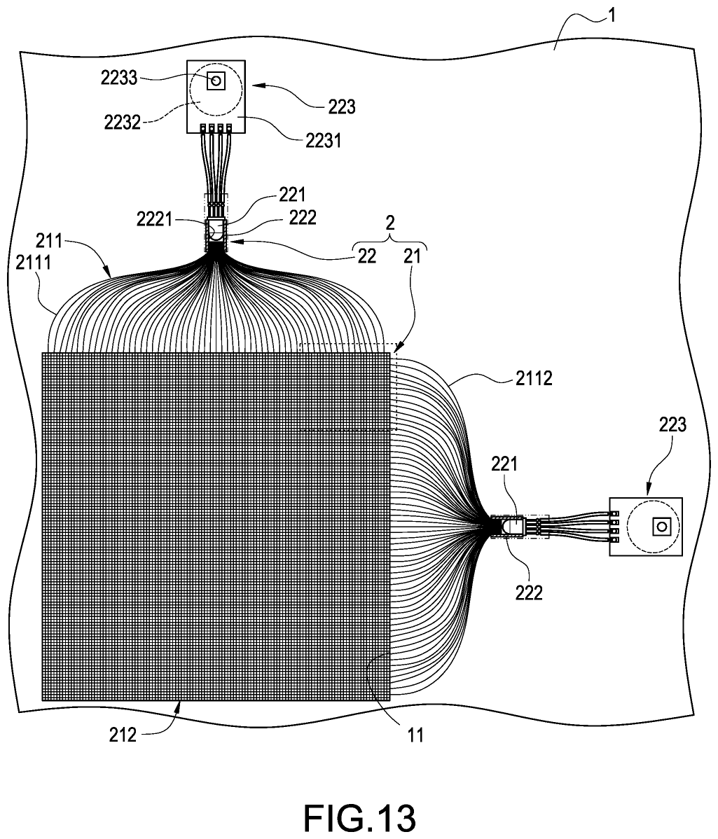

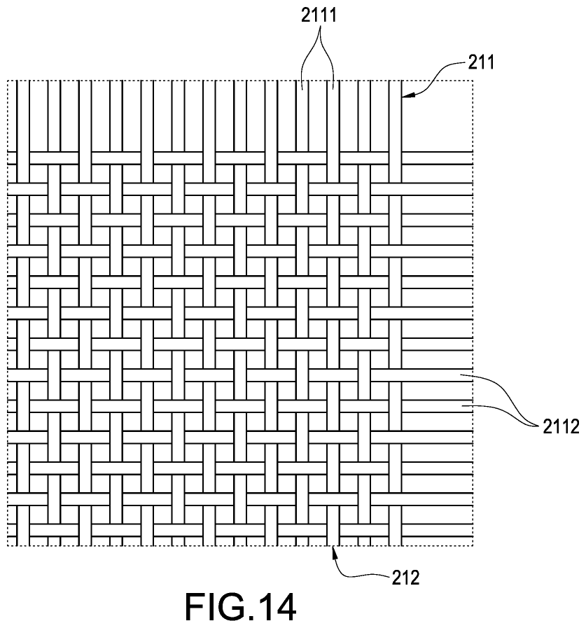

Referring to FIG. 13 and FIG. 14, the third embodiment of the weaving net portion 212 in the present invention is illustrated. The embodiment in FIG. 13 and FIG. 14 is similar to the embodiment in FIG. 1 to FIG. 3. The difference between the embodiment in FIG. 13 to FIG. 14 and the embodiment in FIG. 1 to FIG. 14 is that the plurality of optical fibers 211 are divided into a plurality of warp-wise optical fibers 2111 and a plurality of weft-wise optical fibers 2112. The plurality of warp-wise optical fibers 2111 and the plurality of weft-wise optical fibers 2112 are woven as warp and weft to form the weaving net portion 212.

Specifically, with the plurality of optical fibers 211 being divided into the plurality of warp-wise optical fibers 2111 and the plurality of weft-wise optical fibers 2112, the amounts of the LED 221, fixing bushing 222 and power controlling element 223 are two respectively. One end of one of the fixing bushings 222 is disposed at (or sheathes) terminals of the plurality of warp-wise optical fibers 2111, and terminals of the plurality of warp-wise optical fibers 2111 are tightened (packed) by the same end of the fixing bushing 222. Another end of one of the fixing bushing 222 connects (or sockets) with one of the LEDs 221. One end of another one of the fixing bushings 222 is disposed at (or sheathes) terminals of the plurality of weft-wise optical fibers 2112, and terminals of the plurality of weft-wise optical fibers 2112 are tightened (packed) by the same end of the fixing bushing 222. Another end of another one of the fixing bushing 222 connects (or sockets) with another one of the LEDs 221. Each of the LEDs 221 is electrically connected to each of the power controlling elements 223 respectively. Thus, the multiple warp-wise optical fibers 2111 and the multiple weft-wise optical fibers 2112 are woven as warp and weft, and the meshed light effect brightness may be increased.

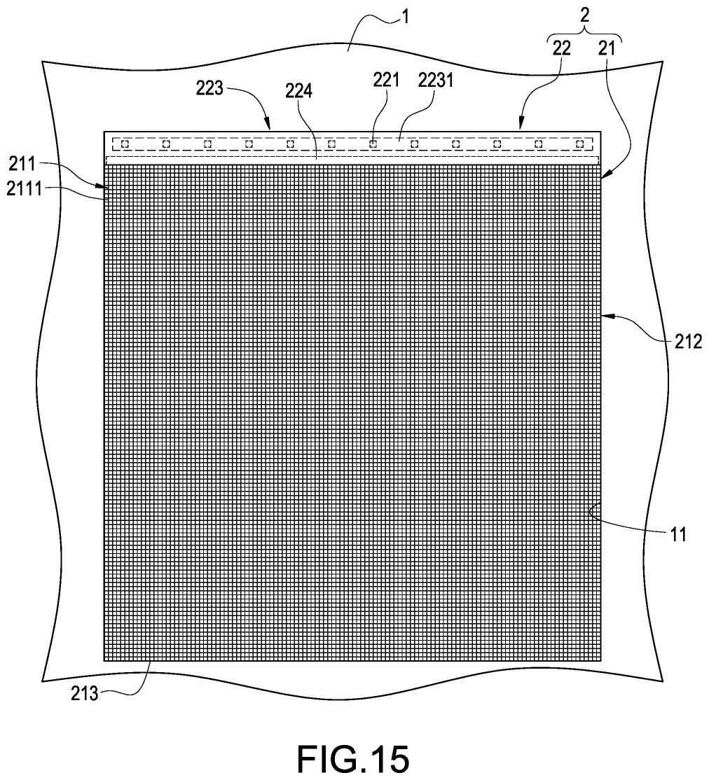

Referring to FIG. 15, the fourth embodiment of the weaving net portion 212 in the present invention is illustrated. The embodiment in FIG. 15 is similar to the embodiment in FIG. 11 and FIG. 12. The difference between the embodiment in FIG. 15 and the embodiment in FIG. 11 and FIG. 12 is that the structure of the light emitting module 22 is different.

Specifically, in some embodiments, the amount of the LED 221 is multiple. In some embodiments, the light emitting module 22 further includes a flexible light guiding bar 224 and a power controlling element 223. The plurality of warp-wise optical fibers 2111 are formed by extending from one side of the flexible light guiding bar 224. The power controlling element 223 and the flexible light guiding bar 224 are fixed and connected with each other. The plurality of LEDs 221 are electrically connected to the power controlling element 223 and disposed correspondingly to the flexible light guiding bar 224.

Similarly, referring back to FIG. 13 and FIG. 14, in some embodiments, when the plurality of optical fibers 211 are divided into the plurality of warp-wise optical fibers 2111 and the plurality of weft-wise optical fibers 2112, the amount of the flexible light guiding bar 224 and the power controlling element 223 are two respectively. The plurality of warp-wise optical fibers 2111 are formed by extending from one side of one of the flexible light guiding bars 224. The plurality of weft-wise optical fibers 2112 are formed by extending from one side of another one of the flexible light guiding bars 224. Each of the power controlling elements 223 and each of the flexible light guiding bars 224 are fixed and connected with each other. The plurality of LEDs 221 are electrically connected to each of the power controlling elements 223 and disposed correspondingly to each of the flexible light guiding bars 224.

As a result, the multiple LEDs 221 may stably transmit light to the multiple optical fibers 211 through the flexible light guiding bar 224. The light emitting efficiency of the weaving net portion 212 may be increased.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A flexible protective cover with a light emitting net cover, the flexible protective cover incorporated with a host (100) and comprising:
a flexible cover body (1), covering an exterior of the host (100) and comprising at least one opening (11), wherein the flexible cover body (1) is composed of a leather, a fabric, a silicone, or a rubber material; and
at least one light emitting net cover (2), comprising:
a light guiding net (21), fixed on the flexible cover body (1) and comprising a weaving net portion (212), wherein the weaving net portion (212) is woven by a plurality of optical fibers (211) and covers the opening (11); and
a light emitting module (22), comprising at least one LED (221) arranged correspondingly to the plurality of optical fibers (211).

2. The flexible protective cover with the light emitting net cover of claim 1, wherein the flexible cover body (1) comprises a through opening (12) and at least one wing sheet (13), one portion of the wing sheet (13) is extended from an inner periphery of the through opening (12) and covering the through opening (12).

3. The flexible protective cover with the light emitting net cover of claim 2, further comprising a first connecting assembly (14), wherein an amount of the wing sheet (13) is multiple, the other portions of the multiple wing sheets (13) are connected with each other by the first connecting assembly (14), the first connecting assembly (14) comprises a zipper, a hook-and-loop fastener, a set of male/female buckles or an adhesive tape, and the opening (11) is disposed on at least one of the wing sheets (13).

4. The flexible protective cover with the light emitting net cover of claim 2, further comprising a second connecting assembly (14′), wherein an amount of the wing sheet (13) is one, another portion of the wing sheet (13) and the inner periphery of the through opening (12) are connected with each other by the second connecting assembly (14′), the second connecting assembly (14′) comprises a zipper, a hook-and-loop fastener, a set of male/female buckles or an adhesive tape, and the opening (11) is disposed on the wing sheet (13).

5. The flexible protective cover with the light emitting net cover of claim 2, further comprising a first connecting assembly (14) and a second connecting assembly (14′), wherein an amount of the wing sheet (13) is multiple, another portion of the wing sheet (13) and the inner periphery of the through opening (12) are connected with each other by the second connecting assembly (14′), still another portions of the multiple wing sheets (13) are connected with each other by the first connecting assembly (14), the first and the second connecting assemblies (14, 14′) comprise a zipper, a hook-and-loop fastener, a set of male/female buckles or an adhesive tape, and the opening (11) is disposed on at least one of the wing sheets (13).

6. The flexible protective cover with the light emitting net cover of claim 1, wherein the flexible cover body (1) comprises a box-shape casing (15), the box-shape casing (15) comprises a front surface (181), a back surface (182), a left surface (183), a right surface (184) and a top surface (185).

7. The flexible protective cover with the light emitting net cover of claim 1, further comprising a third connecting assembly, wherein the flexible cover body (1) comprises a strap-type sheet (16), a left end and a right end of the strap-type sheet (16) are connected with each other by the third connecting assembly (14″), the strap-type sheet (16) comprises a front surface (181), a back surface (182), a left surface (183) and a right surface (184), and the third connecting assembly (14″) comprises a zipper, a hook-and-loop fastener, a set of male/female buckles or an adhesive tape.

8. The flexible protective cover with the light emitting net cover of claim 1, further comprising a third assembling assembly (14″), wherein the flexible cover body (1) comprises a strap-type sheet (16) and two rectangular sheets (17) extended respectively from a upper side and a lower side of the strap-type sheet (16), outer peripheries of the strap-type sheet (16) and the rectangular sheets (17) are connected with each other by the third connecting assembly (14″), the strap-type sheet (16) and the rectangular sheets (17) comprises a front surface (181), a back surface (182), a left surface (183), a right surface (184), a top surface (185) and a bottom surface (186), and the third connecting assembly (14″) comprises a zipper, a hook-and-loop fastener, a set of male/female buckles or an adhesive tape.

9. The flexible protective cover with the light emitting net cover of claim 1, wherein the plurality of optical fibers (211) comprises a plurality of warp-wise optical fibers (2111), the light guiding net (21) further comprises a plurality of weft-wise light transmitting yarns (213), and the weaving net portion (212) is woven as warp and weft by the plurality of warp-wise optical fibers (2111) and the plurality of weft-wise light transmitting yarns (213).

10. The flexible protective cover with the light emitting net cover of claim 9, wherein the light guiding net (21) further comprises a plurality of warp-wise light reflecting yarns (214) interweaved parallelly with the plurality of warp-wise optical fibers (2111), and the weaving net portion (212) is woven as warp and weft by the plurality of warp-wise light reflecting yarns (214) and the plurality of weft-wise light transmitting yarns (213).

11. The flexible protective cover with the light emitting net cover of claim 9, wherein an amount of the LED (221) is one, the light emitting module (22) further comprises a fixing bushing (222) and a power controlling element (223), one end of the fixing bushing (222) is disposed at terminals of the plurality of warp-wise optical fibers (2111) and another end of the fixing bushing (222) connects with the LED (221), and the LED (221) is electrically connected to the power controlling element (223).

12. The flexible protective cover with the light emitting net cover of claim 9, wherein an amount of the LED (221) is multiple, the light emitting module (22) further comprises a flexible light guiding bar (224) and a power controlling element (223), the plurality of warp-wise optical fibers (2111) is extended from one side of the flexible light guiding bar (224), the power controlling element (223) and the flexible light guiding bar (224) are connected with each other, the plurality of LEDs (221) are electrically connected to the power controlling element (223) and disposed correspondingly to the flexible light guiding bar (224).

13. The flexible protective cover with the light emitting net cover of claim 1, wherein the plurality of optical fibers (211) comprises a plurality of warp-wise optical fibers (2111) and a plurality of weft-wise optical fibers (2112), and the weaving net portion (212) is woven as warp and weft by the plurality of warp-wise optical fibers (2111) and the plurality of weft-wise optical fibers (2112).

14. The flexible protective cover with the light emitting net cover of claim 13, wherein an amount of the LED (221) is two, the light emitting module (22) further comprises two fixing bushings (222) and two power controlling elements (223), one end of one of the fixing bushings (222) is disposed at terminals of the plurality of warp-wise optical fibers (2111) and another end of one of the fixing bushings (222) connects with one of the LEDs (221), one end of another one of the fixing bushings (222) is disposed at terminals of the plurality of weft-wise optical fibers (2112) and another end of another one of the fixing bushings (222) connects with another one of the LEDs (221), and each of the LEDs (221) is electrically connected to each of the power controlling elements (223) respectively.

15. The flexible protective cover with the light emitting net cover of claim 13, wherein an amount of the LED (221) is multiple, the light emitting module (22) further comprises two flexible light guiding bars (224) and two power controlling elements (223), the plurality of warp-wise optical fibers (2111) are extended from one side of one of the flexible light guiding bars (224), the plurality of weft-wise optical fibers (2112) are extended from one side of another one of the flexible light guiding bars (224), each of the power controlling element (223) and each of the flexible light guiding bar (224) are connected with each other, the multiple LEDs (221) are electrically connected to each of the power controlling element (223) respectively and disposed correspondingly to each of the flexible light guiding bar (224).

16. The flexible protective cover with the light emitting net cover of claim 1, wherein the light emitting module (22) further comprises at least one power controlling element (223), the power controlling element (223) comprises a circuit board (2231) and battery (2232), the circuit board (2231) is electrically connected with the LED (221) and the battery (2232) is disposed on the circuit board (2231).

17. The flexible protective cover with the light emitting net cover of claim 1, wherein the light emitting module (22) further comprises at least one power controlling element (223), the power controlling element (223) comprises a connector (2234), the connector (2234) is electrically connected with the LED (221) and attachably/detachably connected to the host (100).

18. The flexible protective cover with the light emitting net cover of claim 1, further comprising:
a carrying belt (3), attachably/detachably connected to a top portion of the flexible cover body (1).
